(19) United States
(12) Patent Application Publication
(10) Pub. No.: US 2014/0332250 A1
(43) Pub. Date: Nov. 13, 2014

(54) VEHICLE ELECTRICAL SYSTEM COMPONENT FOR A DATA TRANSMISSION SYSTEM IN A MOTOR VEHICLE

(71) Applicants: Lorena Diaz Ortega, Wolfsburg (DE); Volker Wehrmeyer, Gifhorn (DE); Norbert Friese, Taufkirchen (DE); Martin Huber, Obing (DE)

(72) Inventors: Lorena Diaz Ortega, Wolfsburg (DE); Volker Wehrmeyer, Gifhorn (DE); Norbert Friese, Taufkirchen (DE); Martin Huber, Obing (DE)

(73) Assignees: MD-ELEKTRONIC GMBH, Waldkraiburg (DE); VOLKSWAGEN AG, Wolfsburg (DE)

(21) Appl. No.: 14/353,684

(22) PCT Filed: Sep. 13, 2012
(86) PCT No.: PCT/EP2012/003837

§ 371 Date: Jul. 28, 2014

(30) Foreign Application Priority Data
Oct. 27, 2011 (DE) 10 2011 117 085.9

(51) Int. Cl. H01B 11/10; H01B 11/00

(52) U.S. Cl. CPC H01B 11/105; H01B 11/005
USPC 174/102 R

(57) ABSTRACT

A vehicle electrical system component for a data transmission system in a motor vehicle, in particular for an Ethernet transmission system, having a cable with wires and a plug having wire connection contacts for contacting the wires, wherein the wires have an electrical insulation, wherein a common shielding is arranged around the wires which is enclosed by a common cable sheath, wherein the cable has at least three wires and an electrically conductive drain wire, wherein the drain wire contacts the shielding at least in sections and is contacted to a wire connection contact of the plug.

### PRIORITY CLAIM

This patent application is a U.S. National Phase of International Patent Application No. PCT/EP2012/003837, filed 13 Sep. 2012, which claims priority to German Patent Application No. 10 2011 117 085.9, filed 27 Oct. 2011, the disclosures of which are incorporated herein by reference in their entirety.

### SUMMARY

Illustrative embodiments relate to a vehicle electrical system component for a data transmission system in a motor vehicle, in particular for an ethernet transmission system or BroadR-Reach technology.

### BRIEF DESCRIPTION OF THE DRAWINGS

Disclosed embodiments are explained in more detail below with reference to the figures, in which:

FIG. 1 shows a cross section through a cable in a first disclosed embodiment;

FIG. 2 shows a cross section through a cable in a second disclosed embodiment;

FIG. 3 shows a cross section through a cable in a third disclosed embodiment;

FIG. 4 shows an exploded illustration of a male connector;

FIG. 5 shows a perspective rear view of a male connector; and

FIG. 6 shows schematic wiring of vehicle electrical system component with a control device.

### DETAILED DESCRIPTION OF THE DISCLOSED EMBODIMENTS

Disclosed embodiments provide a vehicle electrical system component for a data transmission system in a motor vehicle, in particular for an ethernet transmission system or BroadR-Reach transmission system, which has a simpler design and is easier to fit.

In this regard, the vehicle electrical system component for a data transmission system in a motor vehicle comprises a cable with wires and a male connector with wire connection contacts for making contact with the wires, wherein the wires have electrical insulation, wherein a common shield is arranged around the wires, which shield is surrounded by a common cable sheath, wherein the cable has at least three wires and an electrically conductive stranded drain wire, wherein the stranded drain wire makes contact, at least sectionally, with the shield and is in contact with a wire connection contact of the male connector. As a result, complex contact-making with the shielding at a shielding plate of the male connector can be dispensed with. The shield can in this case be an inexpensive foil shield, with the result that complex braided shields can be dispensed with. The supposed disadvantage that there is no longer a shield in the region of the male connector is negligible since, in the case of the data rates and signal forms established in accordance with ethernet and in the case of the numbers of coupling points generally arising in a motor vehicle, this does not result in any functional restriction. In this case, the data transmission may take place via a pair of wires, whereas a supply voltage is made available by the third wire and the ground is made available via the stranded drain wire, i.e. optionally the cable has precisely three wires.

In at least one disclosed embodiment, the stranded drain wire, twisted with at least one wire, is guided in the cable. In this case, the stranded drain wire can also be twisted with all of the wires similar to a quad line, which has advantages in terms of transmission response.

In a further disclosed embodiment, the diameter of the stranded drain wire is equal to the insulation diameter of the remaining individual wires, which in particular simplifies twisting and is advantageous for the symmetry of the line from a mechanical and electrical point of view. In this case, the diameter of the stranded drain wire can also be selected to be slightly smaller, with the result that it is, for example, between 80 and 100% of the insulation diameter of the remaining wires.

In another disclosed embodiment, the stranded drain wire has a copper core, to which an electrically conductive coating is applied, wherein the total diameter including the electrically conductive coating has the same or a slightly smaller diameter (80-100%) as/than the insulation of the remaining wires. As has already been mentioned, this design is advantageous for the symmetry of the line from a mechanical and electrical point of view. The electrically conductive coating can in this case be tin or zinc, for example. As a result, firstly savings are made on copper and secondly this also improves the twisting since the cross section of the copper core in the individual wires and the stranded drain wire is the same. The electrically conductive coating can also be an electrically conductive plastic, which reduces costs and makes it possible to use similar material in the three individual wires as well as in the stranded drain wire in terms of twisting properties.

In yet another disclosed embodiment, the wire connection contact for the stranded drain wire in the male connector is matched to the diameter of the stranded drain wire. This is understood to mean that the wire connection contact needs to be suitable for connecting larger diameters since the diameter of the stranded drain wire is larger than the copper core of the wires. This results in a certain degree of asymmetry in the male connector.

Alternatively, the electrically conductive coating of the stranded drain wire can be removed at the wire connection contact of the male connector, with the result that all of the wire connection contacts can have an identical design. This results in slightly more complexity in terms of fitting, but simplifies the design of the male connector.

In a further disclosed embodiment, the male connector has a shielding plate. The advantage of the male connector with a shielding plate consists in its mechanical stability. Therefore, a conventional HSD male connector can be used, but contact is not made with the shielding plate thereof. A further advantage consists in that, correspondingly, the female connectors of a control device into which the vehicle electrical system component is intended to be inserted do not need to be adapted. Alternatively, the shielding plate can be replaced by a plastic part of an identical geometry. Therefore, advantageously individual parts of an existing plug-type system can continue to be used. In the case of new constructions, however, the plastic surrounding housing can also be configured, by suitable configuration of tools, such that the geometry of the previous shielding plate is formed integrally thereon from plastic.

Alternatively, the vehicle electrical system component can have an even simpler design. For this, the vehicle electrical system component comprises an unshielded cable with wires and a male connector with wire connection contacts for making contact with the wires, wherein the wires have electrical insulation, wherein the male connector housing has a shielding plate. Therefore, a quite simple cable can be combined with an HSD male connector to enable ethernet transmission. Alternatively, the shielding plate can also be replaced by a plastic part.

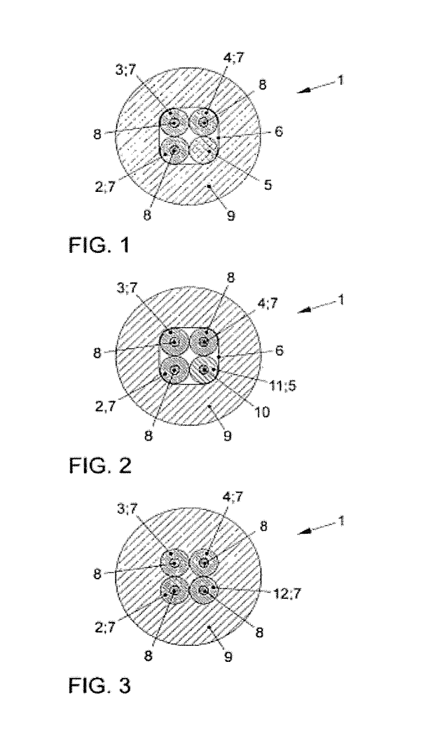

FIG. 1 shows schematically a cross section of a cable 1 in a first disclosed embodiment. The cable 1 comprises three wires 2-4 and a stranded drain wire 5. The three wires 2-4 and the stranded drain wire 5 are surrounded by a common shield 6 which is a foil shield. An insulating cable sheath 9 is positioned around the shield 6 and also provides mechanical protection. The wires 2-4 each have insulation 7 and a copper core 8. The stranded drain wire 5 likewise consists of copper. The copper cores 8 of the wires 2-4 have a cross-sectional area of 0.14 mm2, for example. The wires 2-4 themselves have, for example, a cross-sectional area of 0.35 mm2. The stranded drain wire 5 in this case has the same cross-sectional area as the wires 2-4, i.e. also 0.35 mm2, for example. In this case, the shield 6 rests on the wires 2-4 and the stranded drain wire. The wires 2-4 and the stranded drain wire 5 are twisted in the longitudinal direction in the cable 1. In this case, in each case two wires and one wire and the stranded drain wire 5 can be twisted in pairs or else all three wires 2-4 and the stranded drain wire 5 are all twisted together, such as in the case of a quad line. Owing to the fact that the diameter of the wires 2-4 is equal to that of the stranded drain wire 5, they can be twisted with one another very easily. In this case, the stranded drain wire 5 rests on the shield 6. It is noted here that an insulating filler can be arranged centrally between the wires 2-4 and the stranded drain wire 5, which filler is used in particular for the mechanical stability and for guiding the wires 2-4.

FIG. 2 shows another disclosed embodiment. The only difference of the cable 1 from the embodiment shown in FIG. 1 consists in that the stranded drain wire 5 does not consist completely of copper, but has a copper core 10 and an electrically conductive coating 11, which consists of tin, zinc, a copper-tin alloy or a copper-zinc alloy, for example. Electrically conductive plastics are also conceivable as the coating of the copper core. The copper core 10 in this case may have the same diameter as the copper cores 8 of the wires 2-4. The advantage consists in that the electrically conductive coating 11 is less expensive, while the electrical properties are sufficient for making contact with the shield 6.

FIG. 3 finally shows a cable 1 in a third disclosed embodiment. The cable 1 is an unshielded cable 1 and has four wires 2-4, 12, which each have a copper core 8 and insulation 7.

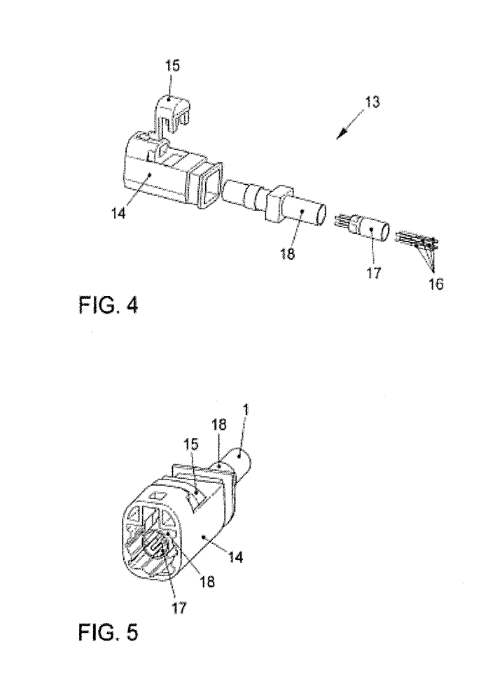

FIGS. 4 and 5 show, by way of example, a male connector 13 for one of the cables 1 shown in FIGS. 1 to 3. The male connector 13 comprises a housing 14 with a lock 15, four wire connection contacts 16, a plastic receptacle 17 for the wire connection contacts 17 and a shielding plate 18. It is noted here that the shielding plate 18 can be dispensed with without being replaced or else can be replaced by a plastic part. The wire connection contacts 16 are used for connecting the wires 2-4, 12 and the stranded drain wire 5 and are crimping contacts. To produce an electrical contact, the insulation 7 of the wires 2-4, 12 is removed and the copper core 8 is crimped with the crimping contact. When connecting a cable 1 as shown in FIG. 1, therefore, the crimping contact needs to be selected to be slightly larger for the stranded drain wire 5 than for the wires 2-4. Correspondingly, the opening for the crimping contact of the stranded drain wire 5 in the plastic receptacle 17 also needs to be slightly larger than for the other wire connection contacts 16. The disclosed embodiments apply similarly for the case of making contact with a cable 1 as shown in FIG. 2 when the electrically conductive coating 11 of the stranded drain wire 5 is not removed prior to crimping. If this coating is removed, however, all four wire connection contacts 16 can have an identical design and correspondingly also have all of the openings of the plastic receptacle 17. When connecting a cable 1 as shown in FIG. 3, all of the wire connection contacts 16 and all of the openings in the plastic receptacle 17 are identical. According to the disclosed embodiments, the shielding plate 18 does not have any electrical function, but only a mechanical stability function, and can therefore also be formed from plastic or even be dispensed with entirely. The shielding plate 18 is in this case substantially cylindrical. It is further noted that the male connector 13 can also be a right-angle male connector and can be both sealed and unsealed.

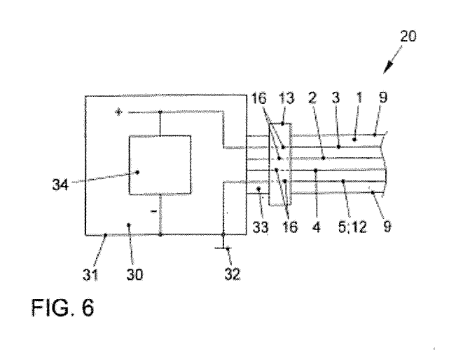

FIG. 6 shows schematically the wiring of a vehicle electrical system component 20 comprising a cable 1 and a male connector 13 with a control device 30. The control device 30 comprises a housing 31, which is connected to the vehicle ground 32. Furthermore, the control device 30 has a female connector 33 and a microprocessor 34, which has a positive supply voltage connection and a negative supply voltage connection which is connected to the vehicle ground 32. In this case, the wire connection contact 16 associated with the stranded drain wire 5 is connected to the negative supply voltage connection, with the result that the shield 8 (see FIGS. 1 and 2) is connected to the vehicle ground 32. The diagonally opposite wires 2, 4 are used for the data transmission from or to the microprocessor 34 and the wire 3 is used for voltage supply and is connected to the positive voltage supply connection of the control device 30.

The advantage consists in that the cable design is very simple and fitting between the cable and the male connector is simplified, wherein, if necessary, existing HSD male connectors can be used. The twisting of the wires in the cable and the untwisting at the male connector can be performed using the existing automatic devices.

Modern data transmission in a motor vehicle requires special lines which are matched to the motor vehicle requirements and are optimized in terms of the transmission response. Standard solutions from the consumer sector are only suitable depending on the vehicle electrical system of modern motor vehicles which is subject to high levels of EMC.

For high-speed data transmission (HSD), for example, star quad cables (quad lines) are known which have two symmetrical pairs of wires in a sheathed line. The individually insulated wires are arranged in a form of a star quad and are twisted together. Then, a common shield is arranged around the wires. At a male connector, the wires are then connected to wire connection contacts and the shield of the cable makes contact with a shielding plate in the male connector. Such vehicle electrical system components are suitable for transmitting data streams in accordance with the LVDS (low voltage differential signal) specification, but also in accordance with the USB, ethernet, GVIF (gigabit video interface) or IEEE 1394 specification. A further technology for transmitting data via pairs of wires is the BroadR-Reach technology by the company Broadcom.

Such data transmission systems are relatively expensive and complex.

### LIST OF REFERENCE SYMBOLS

1 Cable
2-4 Wires
5 Stranded drain wire
6 Shield
7 Insulation
8 Copper core
9 Cable sheath
10 Copper core
11 Electrically conductive coating
12 Wire
13 Male connector
14 Housing
15 Lock
16 Wire connection contact
17 Plastic receptacle
18 Shielding plate
20 Vehicle electrical system component
30 Control device
31 Housing
32 Vehicle ground
33 Female connector
34 Microprocessor

1. A vehicle electrical system component for a data transmission system in a motor vehicle, the component comprising:
a cable with wires; and
a male connector with wire connection contacts for making contact with the wires,
wherein the wires have electrical insulation,
wherein a common shield is arranged around the wires, which shield is surrounded by a common cable sheath,
wherein the cable has at least three wires and an electrically conductive stranded drain wire, and
wherein the stranded drain wire makes contact, at least sectionally, with the shield and is in contact with a wire connection contact of the male connector.

2. The vehicle electrical system component of claim 1, wherein the stranded drain wire, twisted with at least one wire, is guided in the cable.

3. The vehicle electrical system component of claim 1, wherein the diameter of the stranded drain wire is equal to the diameter of the wires.

4. The vehicle electrical system component of claim 3, wherein the stranded drain wire has a copper core, to which an electrically conductive coating is applied, wherein the electrically conductive coating has the same diameter as the insulations of the wires.

5. The vehicle electrical system component of claims 3 and 4, wherein the wire connection contact for the stranded drain wire in the male connector is matched to the diameter of the stranded drain wire.

6. The vehicle electrical system component of claim 4, wherein the electrically conductive coating of the stranded drain wire is removed at the wire connection contact of the male connector.

7. The vehicle electrical system component of claim 1, wherein the male connector has a shielding plate or a plastic part replacing a shielding plate.

8. A vehicle electrical system component for a data transmission system in a motor vehicle, comprising an unshielded cable with wires and a male connector with wire connection contacts for making contact with the wires, wherein the wires have electrical insulation, wherein the male connector housing has a shielding plate or a plastic part replacing a shielding plate.
